(19) United States
(12) Patent Application Publication
(10) Pub. No.: US 2021/0165173 A1
(43) Pub. Date: Jun. 3, 2021

(54) ENERGY-EFFICIENT OPTICAL COMMUNICATION MODULE AND METHOD OF MANUFACTURING THEREOF

(71) Applicant: SHUNSIN TECHNOLOGY (ZHONG SHAN) LIMITED, Zhongshan (CN)

(72) Inventor: GUANG-SHENG HE, Zhongshan City (CN)

(21) Appl. No.: 16/941,785

(22) Filed: Jul. 29, 2020

(30) Foreign Application Priority Data
Nov. 28, 2019 (CN) 201911192490.9

(51) Int. Cl. G02B 6/42

(52) U.S. Cl. CPC G02B 6/4201

(57) ABSTRACT

An optical communication module outputting light directly into an optical fiber and not requiring lenses or other light-guiding elements includes a printed circuit board, an optical-signal transmitter mounted on the printed circuit board and including a light emitting element. An optical fiber is directly connected to the light emitting element, and an optical-fiber connector is connected to the optical fiber. The light emitting element emits light beams into the optical fiber. A method of manufacturing such module is also disclosed.

### FIELD

The subject matter herein generally relates to optical communication modules having optical-signal transmitters directly connecting to optical fibers, and a method of manufacturing thereof.

### BACKGROUND

An optical communication network has the characteristics of low transmission loss, high data confidentiality, total immunity to electromagnetic interference (EMI), and wide bandwidth, and is a main communication method today. The optical communication module is an important basic component in optical communication technology. The optical communication module is used to receive optical signals from optical network and convert the optical signals into electrical signals. The optical communication module can also convert electrical signals into optical signals, and then transmit the optical signals outward through the optical network.

The conventional optical communication module utilizes a vertical-cavity surface-emitting laser (VCSEL) to emit light beams as optical signals. In order for the light beam emitted by the VCSEL to enter into the optical fiber, in the conventional technology, a lens is used to focus the light beam, and then the light beam is reflected by a light-guide element to the optical fiber. Therefore, the conventional optical communication module uses more optical devices such as lenses and light-guide elements, thereby increasing the manufacturing cost of the optical communication module. In addition, the light beam passing through the lens and the light-guide element is inefficient because of energy losses, and this in turn affects the performance of the optical communication module.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a schematic view of an optical communication module in accordance with a first embodiment of the present disclosure.

FIG. 2 is a perspective view of the optical communication module of FIG. 1, some components being omitted.

FIG. 3 is a flowchart of a method for manufacturing the optical communication module in accordance with embodiments of the present disclosure.

FIGS. 4A, 4B, and 4C show intermediate stages of manufacturing the optical communication module.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

The term “connected” is directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

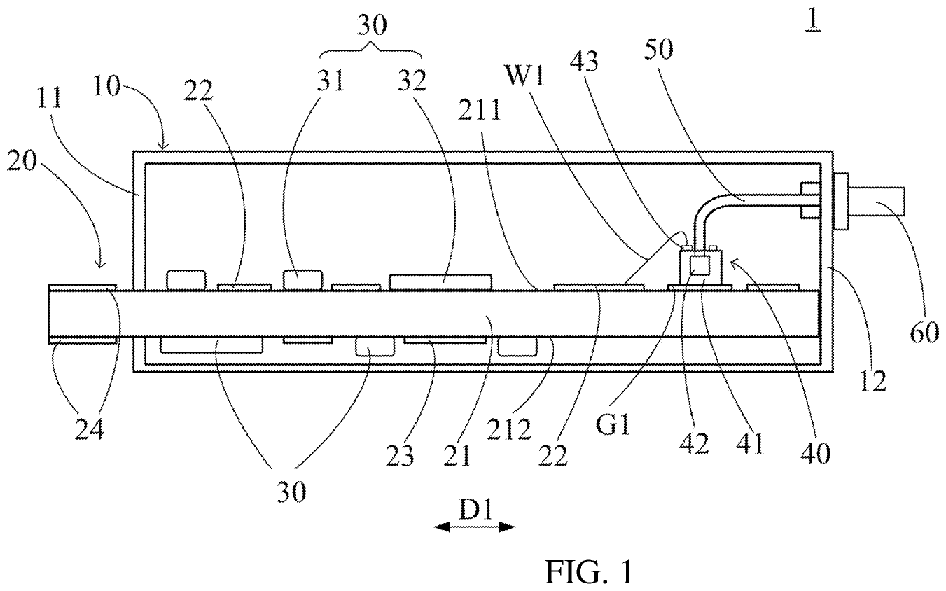

FIG. 1 is a schematic view of an optical communication module 1 in accordance with a first embodiment of the present disclosure. The optical communication module 1 is configured to be mounted in an electronic device, so that the electronic device can receive and/or transmit optical signals. The electronic device may be a computer, a server, or a router, but it is not limited thereto. The optical communication module 1 may be an optical receiving module, an optical transmitting module, or an optical transceiver module. The optical receiving module may receive optical signals, and convert the optical signals to electrical signals. The optical transmitting module may receive electrical signals from the electronic device and convert the electrical signals to optical signals, and the optical signals can be transmitted out via an optical fiber. In addition, the optical transceiver module can integrate the functions of the optical receiving module and the optical transmitting module, and can be used to receive and transmit optical signals.

In this embodiment, the optical communication module 1 is an optical transmitting module, but not limited thereto. The optical communication module 1 includes a housing 10, a printed circuit board 20, chips 30, an optical-signal transmitter 40, an optical fiber 50, and an optical-fiber connector 60. When the optical communication module 1 is an optical receiving module, the optical-signal transmitter 40 is replaced by an optical-signal receiver. The housing 10 may be an elongated structure, extending along an extension direction D1. The housing 10 may be a metal housing configured to shield against electromagnetic waves of the electronic device entering the housing 10, so as to provide electromagnetic protection for components such as the chips 30 and the optical-signal transmitter 40 in the housing 10. In some embodiments, the interior of the housing 10 forms a sealed space, so as to prevent moisture and dust outside the housing 10 from entering the housing 10, and improve the service life and the signal reliability of the optical communication module 1.

The printed circuit board 20 is disposed in the housing 10, and one end of the printed circuit board 20 passes through a side wall 11 of the housing 10. In other words, the end of the printed circuit board 20 is exposed out of the housing 10. The printed circuit board 20 may be an elongated structure extending along the extension direction D1. The printed circuit board 20 may be a rigid printed circuit board (Rigid PCB or RPC). In this embodiment, the printed circuit board 20 includes an insulated substrate 21, a circuit layer (first circuit layer) 22, a circuit layer (second circuit layer) 23, and a connection layer 24. The insulated substrate 21 may be made of rigid materials. The circuit layer 22 is disposed on a top surface 211 of the insulated substrate 21, and made of conductive materials. The circuit layer 23 is disposed on a bottom surface 212 of the insulated substrate 21, and made of conductive materials.

The connection layer 24 may be disposed on the top surface 211 and/or the bottom surface 212 of the insulated substrate 21. In other words, the connection layer 24 is electrically connected to the circuit layer 22 and/or the circuit layer 23. The connection layer 24 can be exposed out of the housing 10. In this embodiment, one end of the printed circuit board 20 can be inserted into the connector of the electronic device (not shown). The connection layer 24 can be in contact with the connector, and thus the printed circuit board 20 can receive electrical signals from the electronic device via the connection layer 24. In some embodiments, the connection layer 24 may be disposed other than on the top surface 211 of the insulated substrate 21. In some embodiments, the connection layer 24 may be disposed other than on the bottom surface 212 of the insulated substrate 21.

The chips 30 are in the housing 10, and mounted on the printed circuit board 20. In this embodiment, the chips 30 are mounted on the printed circuit board 20 by chip-on-board (COB) package. In some embodiments, the chips 30 are mounted on the printed circuit board 20 by surface-mount technology (SMT). The chips 30 can be adhered to the top surface 211 and/or the bottom surface 212 of the insulated substrate 21, and the chips 30 can be electrically connected to the circuit layer 22 and/or the circuit layer 23 by wires (not shown). In some embodiments, the printed circuit board 20 does not include the circuit layer 23, the chips 30 are mounted other than on the bottom surface 212 of the insulated substrate 21.

In this embodiment, all the chips 30 include a control chip 31 and a monitor photodiode (MPD) chip 32, but not limited thereto. The control chip 31 is electrically connected to the monitor photodiode chip 32 and the optical-signal transmitter 40. The control chip 31 is used to drive the optical-signal transmitter 40. In this embodiment, the control chip 31 can drive the optical-signal transmitter 40 according to the electrical signals from the electronic device to generate light beams, so as to make optical signals in the light beams. The monitor photodiode chip 32 is used to detect conditions and states, such as power levels, of the light beams generated by the optical-signal transmitter 40.

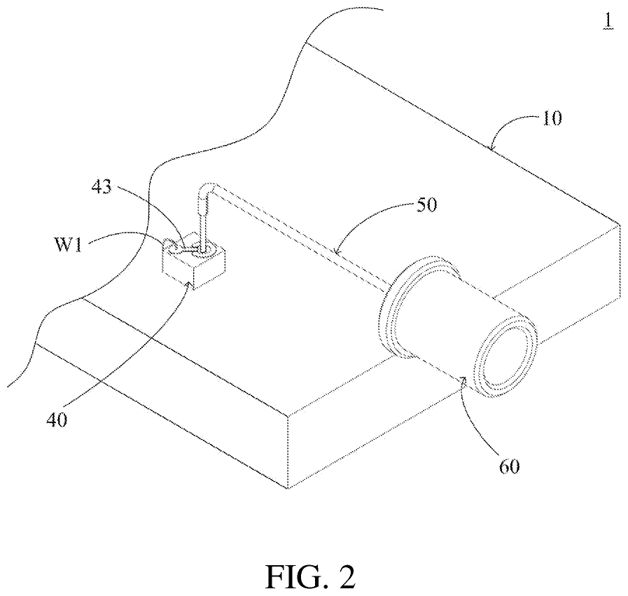

FIG. 2 is a perspective view of the optical communication module 1 of FIG. 1. For the purpose of clarity, some components are omitted in FIG. 2. The optical-signal transmitter 40 is in the housing 10. The optical-signal transmitter 40 can be mounted on the printed circuit board 20, and is electrically connected to the circuit layer 22 (and the monitor photodiode chip 32) via a wire W1. The optical-signal transmitter 40 is electrically connected to the control chip 31 and the monitor photodiode chip 32. The control chip 31 controls the optical-signal transmitter 40 to emit the light beams according to the electrical signals.

The optical-signal transmitter 40 includes a base 41, a light emitting element 42, and an electrode 43. In this embodiment, the base 41 of the optical-signal transmitter 40 is affixed to the top surface 211 of the insulated substrate 21 via a glue G1. In some embodiments, the glue G1 includes epoxy, but is not limited thereto.

The light emitting element 42 is disposed in the base 41. The light emitting element 42 may be a vertical-cavity surface-emitting Laser (VCSEL), used to emit laser. In some embodiments, the light emitting element 42 is a light emitting diode (LED). As shown in FIG. 1 and FIG. 2, the electrode 43 is disposed on the base 41, and electrically connected to the light emitting element 42. In this embodiment, the wire W1 is connected to the electrode 43, and thus the light emitting element 42 is electrically connected to the circuit layer 22.

The optical fiber 50 is connected to the light emitting element 42 and the optical-fiber connector 60. In this embodiment, one end of the optical fiber 50 is directly connected to the light emitting element 42. The light emitting element 42 emits the light beam into the optical fiber 50. In some embodiments, one end of the optical fiber 50 is welded to the light emitting element 42, and thus the light beam emitted by the optical-signal transmitter 40 can directly enter into the optical fiber 50. Therefore, energy losses of light beam can be reduced, and the performance of optical communication module 1 is improved. Moreover, the number of optical devices of the optical communication module 1, such as lenses and light guide elements, is reduced, thereby reducing the manufacturing cost of the optical communication module 1.

The optical-fiber connector 60 is affixed to a side wall 12 of the housing 10. In this embodiment, the side wall 12 is opposite to the side wall 11. The optical-fiber connector 60 and the connection layer 24 are at opposite sides of the housing 10. One end of the optical fiber 50 is affixed in the optical-fiber connector 60.

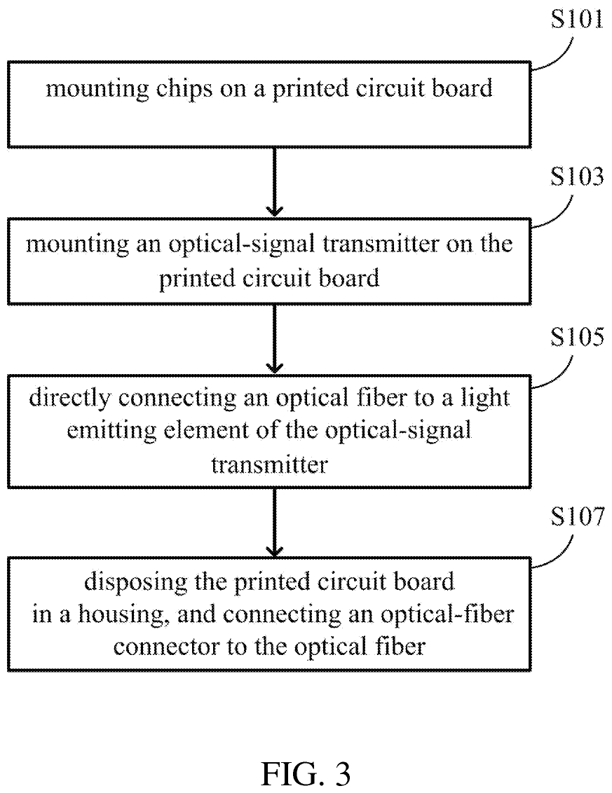

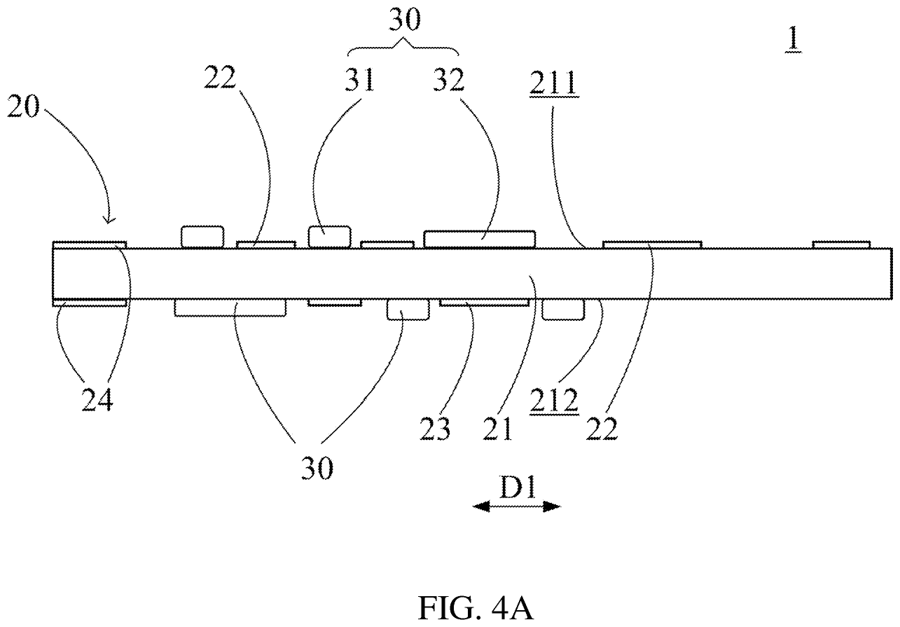

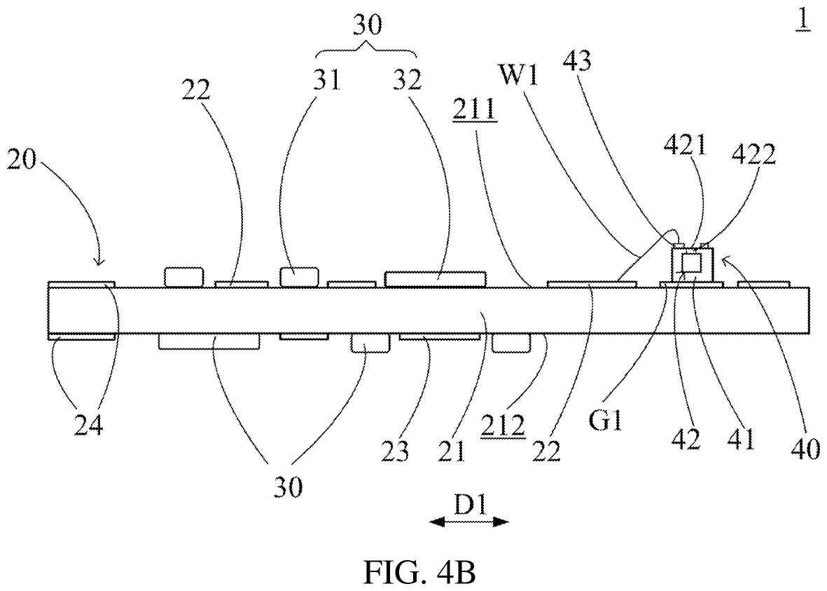

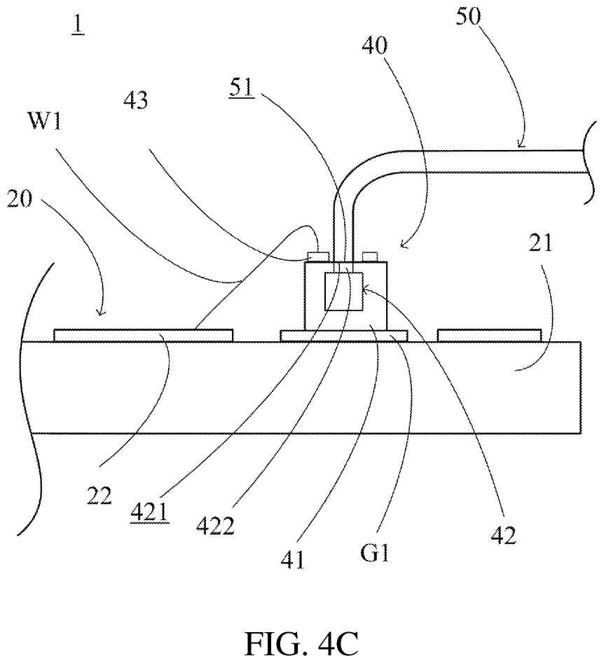

FIG. 3 is a flowchart of a method for manufacturing the optical communication module 1 in accordance with embodiments of the present disclosure. FIG. 4A to FIG. 4C show intermediate stages of manufacturing the optical communication module 1. In FIG. 4A to FIG. 4C, the optical communication module 1 is an example of an optical transmitting module. However, the method of manufacturing the optical communication module 1 can also be applied to an optical receiving module and an optical transceiver module.

In step S101, as shown in FIG. 4A, the chips 30 are mounted on the printed circuit board 20. The chips 30 can be mounted on the printed circuit board 20 by COB package or SMT.

In step S103, as shown in FIG. 4B, the optical-signal transmitter 40 is mounted on the printed circuit board 20. The optical-signal transmitter 40 can be mounted on the printed circuit board 20 by COB package. The base 41 of the optical-signal transmitter 40 is affixed to the top surface 211 of the insulated substrate 21 by the glue G1. Moreover, the optical-signal transmitter 40 is electrically connected to the circuit layer 22 via the wire W1. Therefore, the optical-signal transmitter 40 is electrically connected to the control chip 31 and the monitor photodiode chip 32 via the wire W1.

In step S105, as shown in FIG. 4C, the optical fiber 50 is directly connected to the light emitting element 42 of the optical-signal transmitter 40. In this embodiment, the light emitting element 42 includes a protection layer 422 connected to an exit surface 421. Moreover, the protection layer 422 is located in an opening of the base 41. The light beam generated by the light emitting element 42 is emitted outside the base 41 via the protection layer 422 and the exit surface 421.

In this embodiment, the protection layer 422 and the optical fiber 50 are of the same material, such as glass. The area of the exit surface 421 of the light emitting element 42 is equal to or greater than the area of an incident surface 51 of the optical fiber 50. Therefore, the optical fiber 50 is saturated by the light beam emitted by the light emitting element 42.

In this embodiment, one end of the optical fiber 50 is welded to the exit surface 421 of the light emitting element 42. In some embodiments, the incident surface 51 of the optical fiber 50 is attached to the exit surface 421 of the light emitting element 42. Afterwards, a laser-welding tool emits a high-temperature laser to melt together the incident surface 51 of the optical fiber 50 and the exit surface 421 of the light emitting element 42. Since the protection layer 422 and the optical fiber 50 are of the same material, the optical fiber 50 is totally combined with the light emitting element 42 after the optical fiber 50 and the light emitting element 42 are cooled. The light beam emitted by the optical-signal transmitter 40 can directly enter the optical fiber 50 and reduce energy losses of the light beam. Moreover, there is no need to provide lenses, light guide elements, and/or reflective elements in the light path of the light beam from the light emitting element 42 to the optical fiber 50, thereby reducing the manufacturing cost of optical communication module 1.

In the present disclosure, glass-welding one end of the optical fiber 50 to the light emitting element 42 may have various embodiments. For example, a filler such as glass is placed between the exit surface 421 of the light emitting element 42 and the incident surface 51 of the optical fiber 50. Next, the laser-welding tool emits a high-temperature laser to melt the incident surface 51 of the optical fiber 50 and the exit surface 421 of the light emitting element 42 with the filler. In other words, the filler forms part of the optical fiber 50 and part of the light emitting element 42.

In step S107, as shown in FIG. 1, the printed circuit board 20 is disposed in the housing 10, and one end of the printed circuit board 20 passes through the side wall 11 of the housing 10. Afterwards, the optical-fiber connector 60 is connected to the optical fiber 50, and affixed to the side wall 12 of the housing 10, and then the assembly of the optical communication module 1 is finished.

By the optical fiber 50 directly connecting the optical-signal transmitter 40, the light beam emitted by the optical-signal transmitter 40 can directly enter into the optical fiber 50 to reduce the energy loss of the light beam, thereby improving the performance of the optical communication module 1. Moreover, the optical communication module 1 eliminates the need for optical devices such as lenses and light guide elements, thereby reducing the manufacturing cost of the optical communication module 1.

Many details of the optical communication module are often found in the art, and thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An optical communication module, comprising:
a printed circuit board;
an optical-signal transmitter disposed on the printed circuit board, and comprising a light emitting element;
an optical fiber directly connected to the light emitting element; and
an optical-fiber connector connected to the optical fiber,
wherein the light emitting element is configured to emit a light beam entering into the optical fiber.

2. The optical communication module as claimed in claim 1, wherein the printed circuit board comprises an insulated substrate and a circuit layer disposed on the insulated substrate, the optical-signal transmitter is affixed to the insulated substrate via a glue, and the optical-signal transmitter is electrically connected to the circuit layer via a wire.

3. The optical communication module as claimed in claim 1, further comprising a housing, wherein the printed circuit board is disposed in the housing, one end of the printed circuit board passes through a side wall of the housing, and the optical-fiber connector is affixed to another side wall of the housing.

4. The optical communication module as claimed in claim 1, further comprising a plurality of chips disposed on the printed circuit board, wherein the plurality of chips include a control chip and a monitor photodiode chip, and the optical-signal transmitter is electrically connected to the control chip and the monitor photodiode chip.

5. The optical communication module as claimed in claim 1, wherein one end of the optical fiber is welded to an exit surface of the light emitting element.

6. A manufacturing method of an optical communication module, comprising:
mounting an optical-signal transmitter on a printed circuit board;
directly connecting an optical fiber to a light emitting element of the optical-signal transmitter; and
connecting an optical-fiber connector to the optical fiber.

7. The manufacturing method of the optical communication module as claimed in claim 6, wherein the directly connecting the optical fiber to the light emitting element of the optical-signal transmitter comprises:
comprising welding one end of the optical fiber to an exit surface of the light emitting element.

8. The manufacturing method of the optical communication module as claimed in claim 6, wherein the mounting the optical-signal transmitter on the printed circuit board comprising:
comprising affixing the optical-signal transmitter to an insulated substrate of the printed circuit board by a glue, and electrically connecting the optical-signal transmitter to a circuit layer of the printed circuit board by a wire.

9. The manufacturing method of the optical communication module as claimed in claim 6, further comprising:
mounting a plurality of chips to the printed circuit board, wherein the plurality of chips include a control chip and a monitor photodiode chip, and the optical-signal transmitter is electrically connected to the control chip and the monitor photodiode chip.

10. The manufacturing method of the optical communication module as claimed in claim 6, further comprising:
disposing the printed circuit board in a housing, and affixing the optical-fiber connector to a side wall of the housing, wherein the printed circuit board passes through the housing.
